(19) United States
(12) Patent Application Publication
(10) Pub. No.: US 2018/0172629 A1
(43) Pub. Date: Jun. 21, 2018

(54) ELECTROPHORESIS APPARATUS AND USE THEREOF

(71) Applicant: Virongy L.L.C., Manassas, VA (US)

(72) Inventors: Zidu Zhang, Beijing (CN); Yuntao Wu, Manassas, VA (US)

(21) Appl. No.: 15/838,579

(22) Filed: Dec. 12, 2017

Related U.S. Application Data
(60) Provisional application No. 62/434,634, filed on Dec. 15, 2016.

(51) Int. Cl. G01N 27/447

(52) U.S. Cl. CPC G01N 27/44721; G01N 27/44747

(57) ABSTRACT

An electrophoresis apparatus having a blue light system comprises a tiltable chamber for electrophoresis. The tiltable chamber operates in a horizontal position, a vertical position, and in one or more inclined positions having an angle between the angle of the horizontal position and the angle of the vertical position. The electrophoresis apparatus is usable for separating molecules.

### CROSS REFERENCE

The present application claims priority benefit of U.S. Provisional Application No. 62/434,634, filed Dec. 15, 2016, which application is incorporated by reference herein in its entirety.

### FIELD

An electrophoresis apparatus has a blue light system with a tiltable electrophoresis chamber in order to provide a convenient angle of view. Although usable in other ways, the electrophoresis apparatus is usable to separate biological molecules of various sizes.

### INTRODUCTION

Gel electrophoresis separates biological molecules of various sizes. A gel electrophoresis experiment is performed where DC voltage is applied horizontally or vertically to a porous medium (usually an agarose gel) immersed in electrolyte solution. Sample molecules of different size loaded to the slot in the medium close to either the positive electrode or the negative one will migrate at different speeds, and the location of them after certain time can be revealed by shining UV light to the gel to trigger the fluorescence in the dye attached to target molecules.

As UV and the associated dye are harmful to humans, a green fluorescent dye triggered by blue light was developed to monitor the progress of the experiment in real time. In commercial devices, blue light is generated by LED arrays shooting into the sample, and the observers will see the green fluorescence from a perpendicular direction through a filter which lets the fluorescence pass while blocking the blue light. However, current blue light devices are horizontally oriented, and they suffer from bulky components, so the users have to observe the fluorescence from overhead, which is not user-friendly. On the other hand, vertically oriented devices which can be viewed from the side do not have a blue light panel, and it is still inconvenient to see when placed on a low lab bench.

### BRIEF DESCRIPTION OF THE DRAWINGS

FIG. 1 is an illustration of component pieces of an electrophoresis apparatus.

FIG. 2 is an illustration of a front panel of an electrophoresis apparatus.

FIG. 3 is an illustration of an illustrative gel cassette.

FIG. 4 is an illustration of a chamber frame.

FIG. 5 is an illustration of a partition panel.

FIG. 6 is an illustration of an LED panel.

FIG. 7 is an illustration of an LED cover.

FIG. 8 is an illustration of a deflector.

FIG. 9 is an illustration of an assembled supporting structure including a back mount, a stand, and a foot.

FIG. 10 is an illustration of supporting structure components including a back mount, a stand, and a foot.

FIG. 11A and FIG. 11B are an illustration of a cap for sealing the electrophoresis chamber so it will not leak when tilted.

FIG. 12 is an illustration of a magnetic stand using magnets as rotational pivot point instead of knuckle and nut.

FIG. 13 is an illustration of a magnetic clip, which can be used for removing a molding comb from a gel cassette (FIG. 15), and it can also pick up the gel from the chamber (FIG. 14).

FIG. 14 is an illustration of the use of a magnetic clip for removing an electrophoresis gel from the chamber.

FIG. 15 is an illustration of the use of a magnetic clip for removing a molding comb from a gel cassette.

### DETAILED DESCRIPTION

The accompanying drawings, which are incorporated in and constitute a part of this specification, illustrate embodiments and together with the description, serve to explain the principles.

Reference will now be made in detail to embodiments, and examples of which are illustrated in the accompanying drawings. Wherever possible, the same reference numbers will be used throughout the drawings to refer to the same or like parts.

Current blue light devices are horizontally oriented, and they suffer from bulky components, so the user must observe the fluorescence from overhead, which is not user-friendly, particularly while working at a low lab bench. On the other hand, vertically oriented devices which can be viewed from the side do not have a blue light panel, and are still inconvenient for observing when placed on a conventional low lab bench.

Recognizing and confronting these problems, the present inventors contemplated a gel electrophoresis having a blue light system with a novel tiltable electrophoresis chamber in order to provide a convenient angle of view.

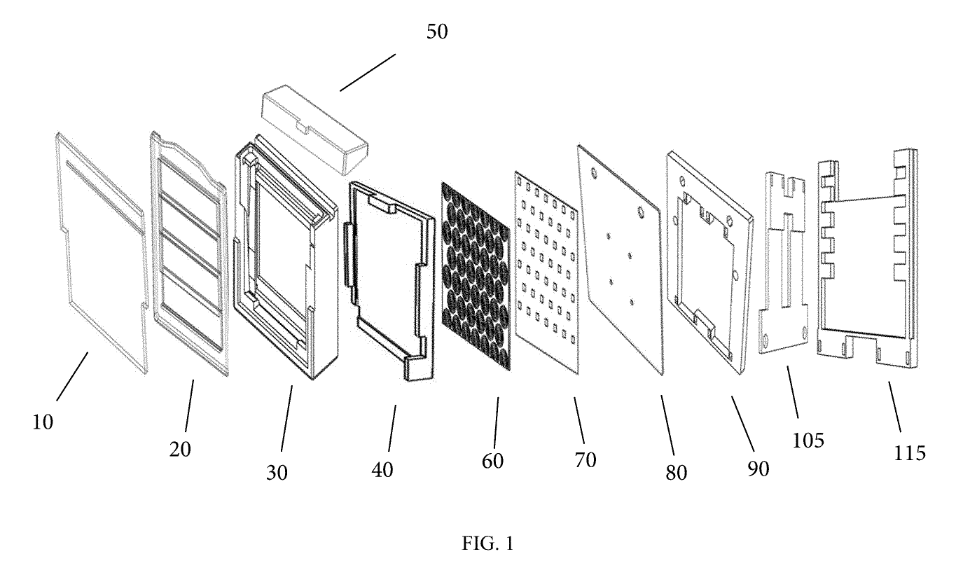

In FIG. 1, the embodiment has a dimension of 4.3 in×4.4 in×1.7 in, which is a fraction thicker than the plastic gel used to hold the DNA samples. In so doing, the inventors contemplated and designed component parts, such as LED panel, LED cover, deflector, magnetic stand, each of which has novel design and has applicability for other lighting and non-lighting applications. In this way, and while the present example relates to gel electrophoresis, the present components, designs, methodologies, and the like find use in other applications. For example, the deflector design can be used for thin light sheet of high luminosity and trans-illuminators. The magnetic joint can used to replace rotational hinges such as a door hinge, and it can also be used for low friction rotational joints.

The gel and buffer chamber are placed in the front compartment for easy access. A blue light trans-illuminator is placed in the rear compartment of the device covered with a deflector and a blue light filter. At the rear of the case, the inventors designed a supporting stand to enable easy reading of the results in an inclined position. The stand is also detachable offering protection from overloading and easy storage.

Water resistant and heat dissipation is achieved by mechanical properties of the case material. ABS and alternatives with good chemical and thermal stability can be used. There also should be a good solvent based adhesive for easy assembly of certain parts. Magnets are used in certain structures to provide both flexibility and rigidity.

In no way limiting, and merely illustrative of the inventors' concepts and techniques, the inventors provide the below designs and descriptions. It is understood that modifications, variations, and the like fall within the spirit and scope.

FIG. 1 illustrates an embodiment of a gel electrophoresis chamber 100, including front panel 10, gel cassette 20, chamber frame 30, partition panel 40, cap 50, deflector 60, LED panel 70, LED cover 80, back mount 90, stand 105, and foot 115.

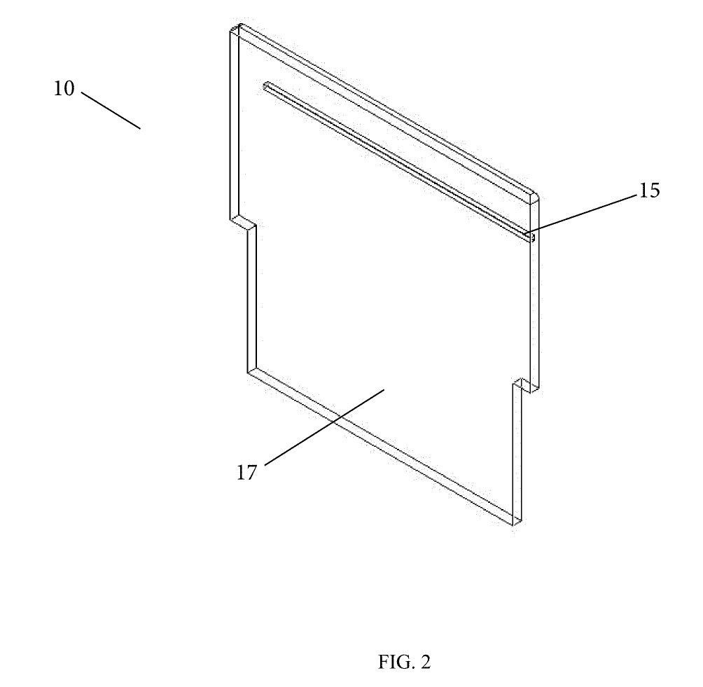

FIG. 2 illustrates an embodiment of front panel 10. Front panel 10 is a transparent plastic panel attached or glued to the main chamber body. It has horizontal groove 15 on the upper part to place the electrode wire for the reaction; the groove for the electrode may be placed on the main chamber body instead of the panel, depending on the manufacture process. Front surface 17 of the panel is covered with filter material (not shown) to block the blue light from the light source while letting the green fluorescent light from samples pass through.

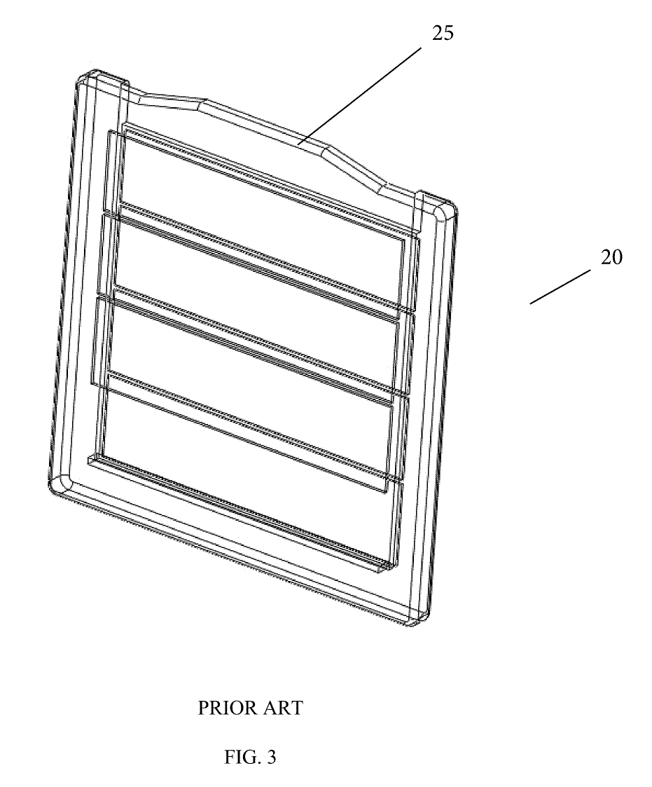

FIG. 3 illustrates an embodiment of gel cassette 20. Gel cassette 20 is a conventional, commercially available plastic gel cassette with dimensions that accommodate the instant electrophoresis functionality. Gel cassette 20 has molding comb 25.

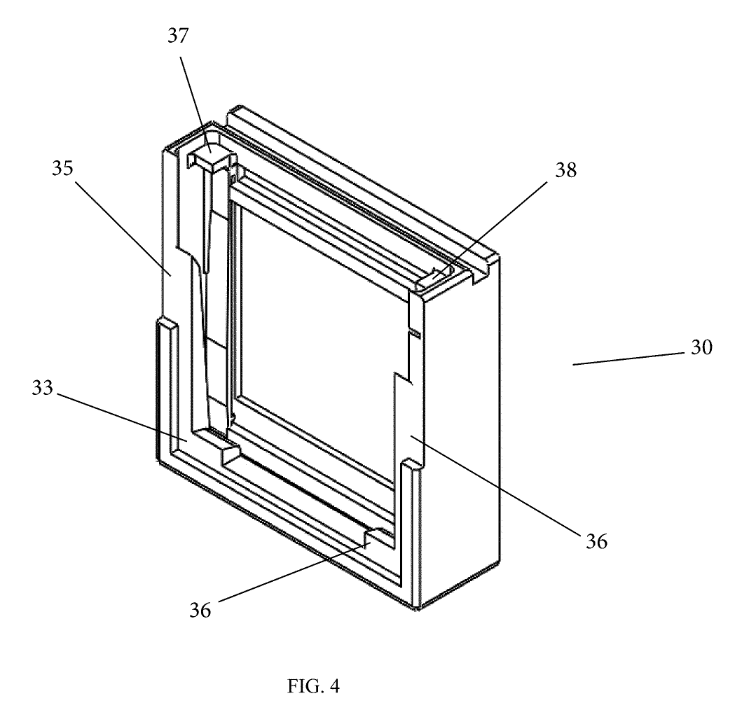

FIG. 4 illustrates an embodiment of chamber frame 30. Chamber frame 30 was designed by the present inventors to afford several advantages, including but not limited to LED illumination from behind, gel cassette placement, electrode configuration, and tiltable angles.

A. LED Illuminating from Behind

The present inventors placed LED panel 70 in the rear part of chamber frame 30, separated from the front part of chamber frame 30 for electrical isolation and waterproofing. This design allows heat dissipation, since when voltage is applied to the electrodes, the buffer solution slowly heats, which could negatively impact experiment results. Shielding from LED panel 70 prevents heat radiation from penetrating through to the front chamber.

Placing the LEDs on the side of the front viewing chamber as a conventional approach requires complicated waterproofing and power supply module, which the present inventors realized do not outweigh the benefits.

Deflector 60 along with filter (not shown) and shielding material are also integrated into the rear part of chamber frame 30 as explained in the later section.

### B. Placement of Gel Cassette 20

1. Rail

A Pair of rails 35-36 is used to keep the gel cassette 20 in position on front-back direction during operation, with pair of blockers 33-34 at the bottom of the chamber frame, gel cassette 20 is kept leaning forward to make it easy to put in and release.

2. Top Blockers 37-38

Two blockers 37-38 on the top lock gel cassette 20 in position on height direction. While gel cassette 20 in locked, the user can pull out molding comb 25 using a clip upwardly without pulling out gel cassette 20 itself.

### C. Configuration of Electrodes

The voltage applied to electrodes for an electrophoresis experiment is typically at 90 V, 150 mA. Since they are immersed into the buffer solution, good insulation must be provided by back panel 40, which is located in the middle of chamber frame 30, separating front and rear parts of chamber frame 30. The positions of the electrodes are critical to electrophoresis experiment, since only a vertically symmetric electric field can drive the molecules in a straight line, yielding measurable results. Otherwise the molecules might follow a skewed path in the gel thus rendering the results invalid.

The present inventors placed the cathode at the top and anode at the bottom since DNA molecules are negatively charged. Both electrodes are made of platinum of equal length, soldered with a copper wire covered with insulation, which is then soldered onto the banana connector on the back of the case.

The top electrode (not shown) is mounted to front panel 10 in the drawing, and bottom electrode (not shown) is on chamber body 30. This configuration may be mirrored such that the top electrode is placed on the chamber body with the same height while the bottom electrode is moved to the front side, depending on the fabrication process.

### D. Tiltable Angle

Since this is a compact design, the present inventors contemplate having the ability to both load and view the sample easily, without the need of extra hand holding the case itself. In one embodiment, the present inventors designed a supporting stand at the back mount. Easily released from the back mount, the stand holds the case in a tilted position. With the removable cap detached, sample loading is made easy with a clearer vision of the sample position in the gel cassette.

### E. Power Jack, Banana Connector

1. Placement of Interface

A power jack, similar to banana connector (not shown), acts as an interface, connecting external power to its core component. Position is one of the main considerations in the illustrative design. Based on the LED circuit design, placing a power jack on the bottom right side of the case frame offers the shortest distance between power jack and LED panel 70, thus eliminating possible failure from short and open circuit. Assembly time also shortens for easier soldering and alignment.

A banana connector is placed on the back utilizing the extra space freed from LED panel 70. This allows less confliction with cap 50, which is essential to the user experience. Placing them on the top half of the case provides a user-friendly experience, allowing a user to easily plug in the power cords yet isolated from LED panel 70.

2. Electrical and Water Insulation

Additional concerns for the two interface component are water resistance and electrical isolation, which are needed for both operation and safety. A sealing material is applied to the gap between the jack and the opening frame on the case as well as the gap around the openings of the banana connector. This offers more rigidity in addition to electrical isolation and water insulation.

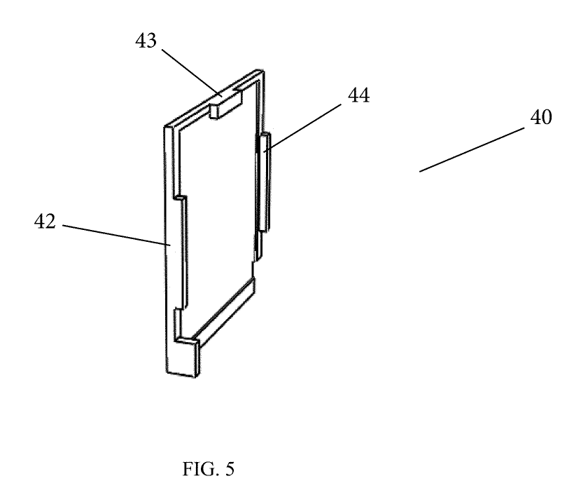

FIG. 5 illustrates an embodiment of partition panel 40. Partition panel 40 is transparent plastic and is the back wall of the chamber frame. Partition panel 40 has blocks 42-44 on the back side to indicate the position of LED panel. Missing corner 45 at the bottom is for accommodating a power jack.

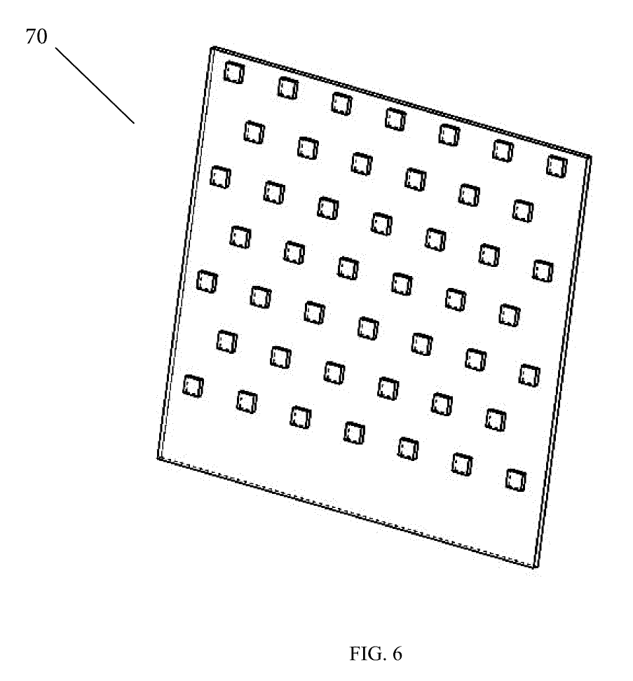

FIG. 6 illustrates an embodiment of LED panel 70. The hexagonal array of LED panel 70 provides relative uniform lighting by minimizing the dark spot among adjacent LEDs. The alignment is based on the specific directionality of the LED component used; exact positions might differ based on mass production supply. The density of LEDs is matched with observation area and component specification to obtain best performances.

The circuitry design for the on-board LEDs is responsible to enable steady operations as well as overload protection. All LEDs have equal light intensity which demands equal current flowing on each parallel branch and when one or more LED fails, the rest should continue to operate as normal. A current balancing circuit in combination with open circuit protection are used for this purpose. The material for the printed circuit board is chosen to be aluminium for better heat dissipation from the back of the case; temperature is expected to reach as high as 75° C.

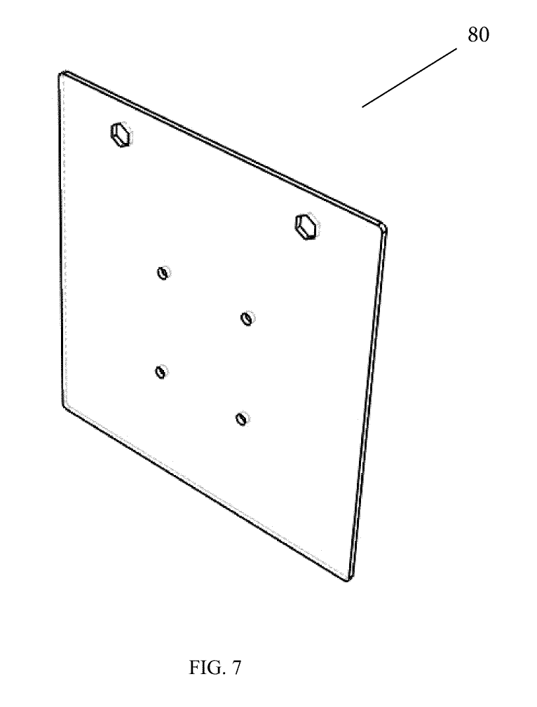

FIG. 7 illustrates an embodiment of LED cover 80. LED cover 80 provides humidity insulation as well as heat dissipation path. LED cover 80 must not deform nor granulate under high temperature cycles to maintain water resistant.

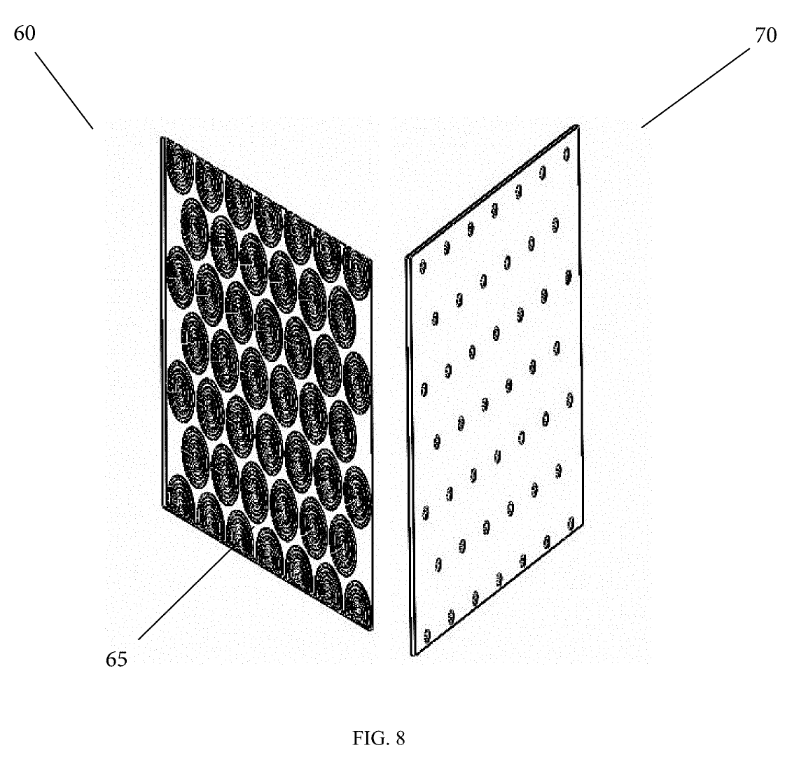

FIG. 8 illustrates an embodiment of a deflector 60 front and back side. Deflector 60 is a piece of transparent material with patterns on both sides in order to deflect the light from LED to cover the entire area at uniform luminosity without losing too much power. The LED side of the deflector has a dent for each LED to diffuse the normal incident light into a more dispersed light cone. The chamber side of the deflector has concentric grooves 65 for each LED light cone to further disperse the light in order to shine the sample area uniformly. The size of concentric grooves is based on the dispersion angle of LED, which in turn determine the number of grooves and thus its depth, needed for best performance. In this design each set of concentric groove consist of 8 equally spaced grooves, with same depth. The groove will reduce the light intensity and for this reason there is spacing between each set of the grooves that coincides with relatively darker area of the LED Panel. The result is a uniform intensity light shining into the chamber.

A blue filter film (not shown) is attached to the chamber side of the deflector to block undesired light in the spectrum which does not trigger the fluorescence. A heat shield layer is applied between the deflector ring layer and the filter to block heat radiation passing through.

### F. Supporting Structure

As mentioned above, the present inventors developed supporting structure permitting a user to easily monitor and read results in an inclined position. The stand is also detachable offering protection from overloading and easy storage.

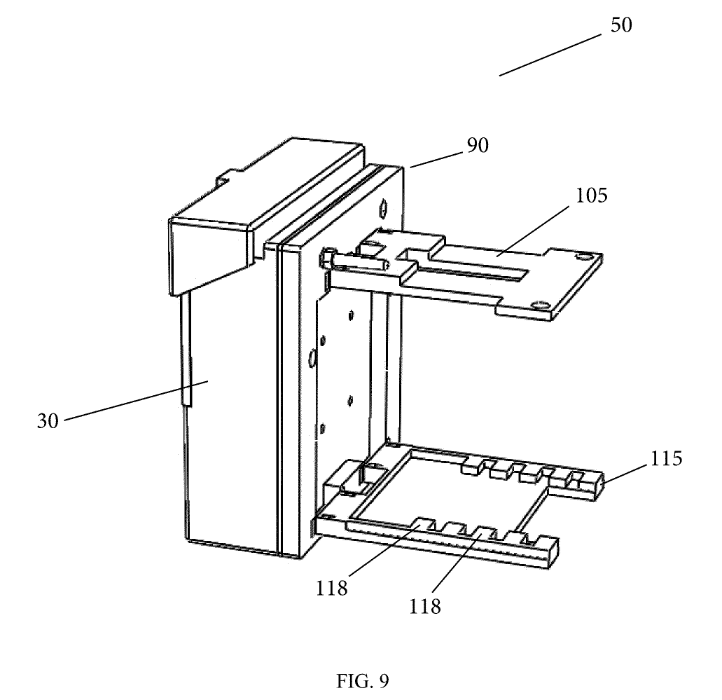

FIG. 9 illustrates an embodiment of an assembled supporting structure including back mount 90, stand 105, and foot 115.

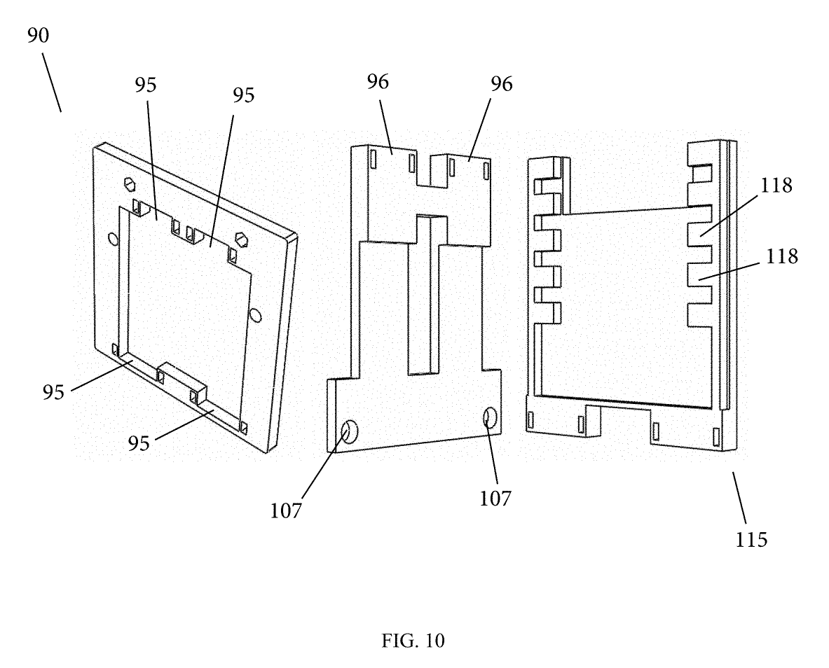

FIG. 10 illustrates an embodiment of components of a supporting structure including back mount 90, stand 105, and foot 115. The supporting structure on the back of chamber 30 enables it to be tilted at various angles. Back mount is attached to the LED cover 80 to provide a firm support. Foot 115 and the stand 105 are attached to the mount using magnetic joints, so they can be detached from the mount to prevent damage if too much force is applied accidently. Notches 118 in foot 115 are positioned to support stand 105 at its base so that the triangle formed by back mount 90, stand 105, and foot 115 define the view angle. Rectangular slots 95-96 are for the magnetic joints, and the circular slots 107 are for the magnets holding the parts in places with moderate strength.

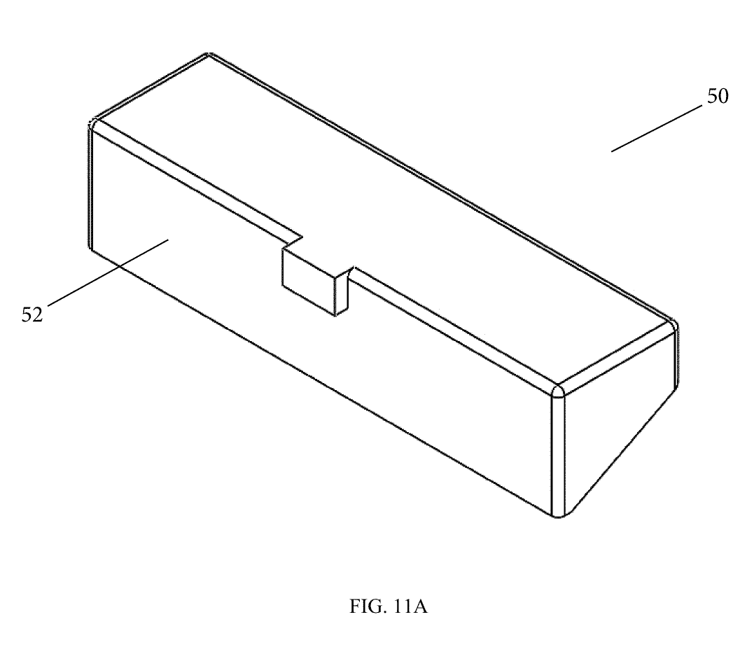

FIGS. 11A and 11B illustrate an embodiment of cap 50 which is transparent and is used to seal the chamber so it will not leak when tilted. The frontal side of the cap 52 has filter layer identical to the front panel to prevent the leakage of blue light. The water seal between cap 50 and the chamber 30 is accomplished by press-fit rubber seal 54.

### G. Deflector

Deflector 60 can be used for general lighting purpose providing higher efficiency diffraction design to the mainstream lighting market. The design allows LED panel to be placed directly underneath the deflector without appearing as individual spotlights. Conventional approach placed the LEDs on the side of a transparent plate deflecting the light to uniformity. It also requires a reflective film on one side to reduce power loss. Uniform light intensity is achieved with small thickness on the expense of lower LED power. Our design on the other hand generates better uniformity with same number of LEDs in a thinner space.

The design concept is to use an etching method to create concentric grooves, not necessarily circular, to deflect light in all directions. The number of grooves and their depth depend on LEDs used in the panel.

H. Stand with Magnetic Hinge

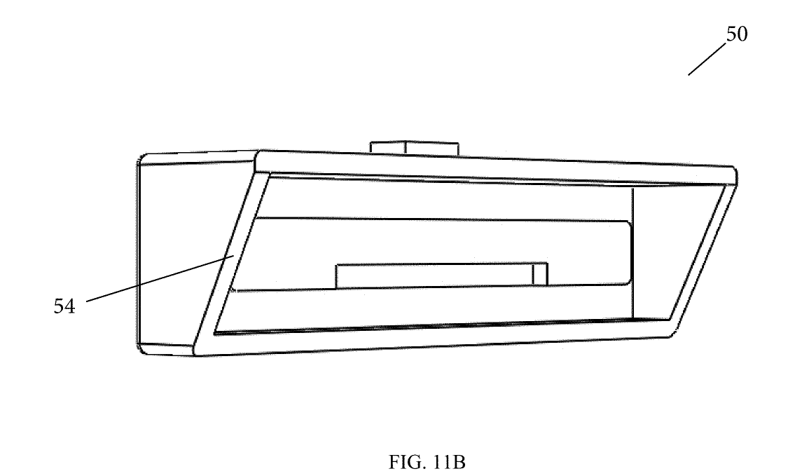

FIG. 12 illustrates an embodiment of stand 105 which uses magnets as rotational pivot point instead of knuckle and nut. The instant magnetic stand uses magnetic hinges 120 instead of a conventional mechanical shaft-housing design. As shown in FIG. 12, stand 105 has two hinges 120 and each side of a hinge has two magnets 130-140 facing each other with opposite polarity. The magnetic attraction will hold stand 105 on back mount 90 while allowing them to detach under overload without shattering. The magnetic joint can be applied to all similar scenarios demanding a firm but separable joint. Also, the magnetic joint can be implemented to reduce frictions of a rotational joint.

### I. Magnetic Clip

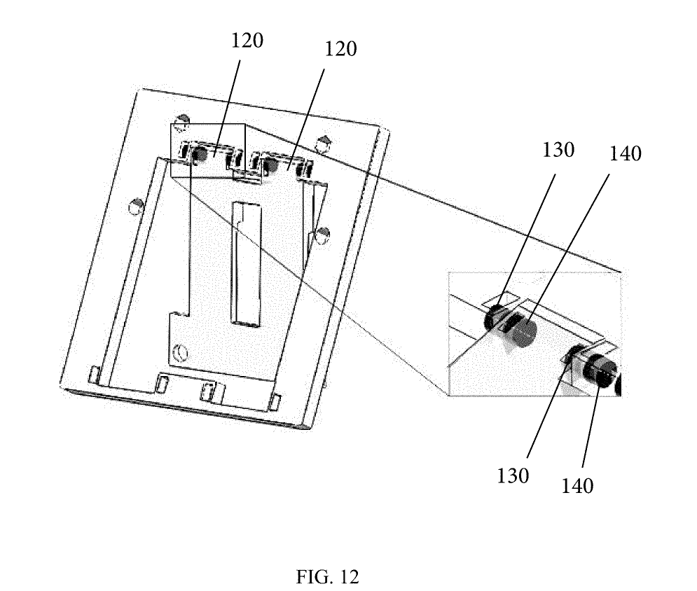

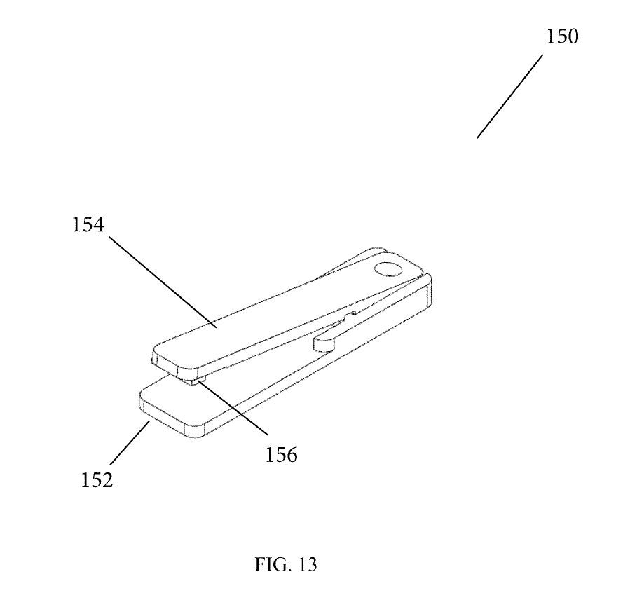

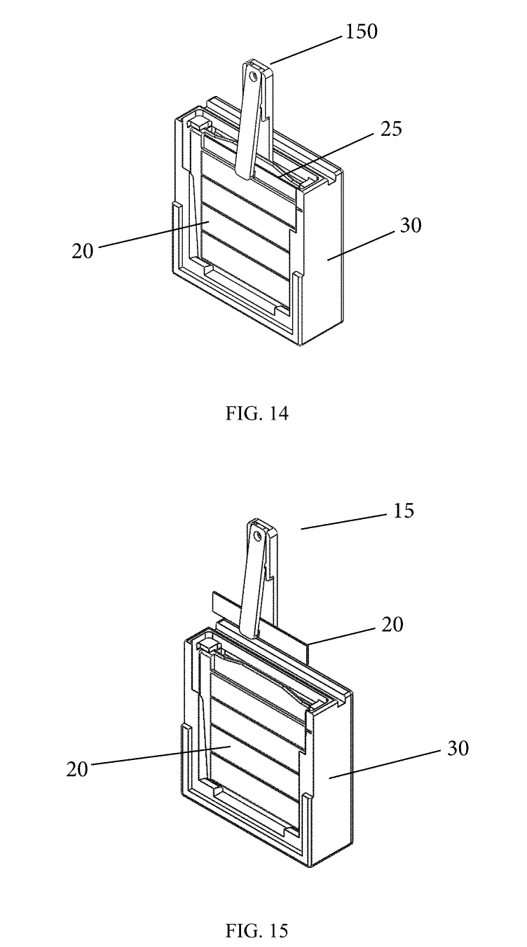

FIG. 13 shows an embodiment of magnetic clip 150, which can be used for removing molding comb 25 from gel cassette 20 (FIG. 15) and can also pick up gel 20 from the chamber 30 (FIG. 14).

Clip 150 has three parts, including bottom bar 152, upper bar 154, and rubber 156 attached to the bottom tip of the upper bar. A magnet is embedded into each bar 152-154 to make them stick together while remaining separable. Rubber 156 makes the friction of upper bar 154 much larger than bottom bar 152, so removing comb 25 from gel cassette 20 will be smooth. Gel cassette 20 is locked in chamber frame 30 by two top stoppers 37-38 repetitive.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. An electrophoresis apparatus having a blue light system and comprising a tiltable chamber for electrophoresis, wherein the tiltable chamber is configured to operate in a horizontal position, a vertical position, and in one or more inclined positions having an angle between the angle of the horizontal position and the angle of the vertical position, with the proviso that the angles of the one or more inclined positions are defined without a user's holding the chamber.

2. The electrophoresis apparatus of claim 1, wherein the tiltable chamber is configured to operate in at one or more inclined positions having an angle between the angle of the horizontal position and the angle of the vertical position.

3. The electrophoresis apparatus of claim 1, wherein the chamber includes a chamber frame containing an LED panel having the blue light system and having a front side positioned to a viewable surface of the chamber; and a deflector between the LED panel and the viewable surface of the chamber.

4. The electrophoresis apparatus of claim 3, wherein the deflector has a concentric pattern of grooves for dispersing light from the blue light system in the chamber.

5. The electrophoresis apparatus of claim 4, wherein the concentric pattern of grooves includes concentric circles.

6. The electrophoresis apparatus of claim 3, further comprising a gel cassette between the deflector and the viewable surface of the chamber.

7. The electrophoresis apparatus of claim 6, wherein the deflector has a concentric pattern of grooves for dispersing light from the blue light system in the chamber.

8. The electrophoresis apparatus of claim 7, wherein the concentric pattern of grooves includes concentric circles.

9. The electrophoresis apparatus of claim 3, further comprising a detachable stand reversibly attachable to the chamber frame.

10. The electrophoresis apparatus of claim 9, wherein the detachable stand comprises a back mount connected to the chamber frame and a stand connected to the back mount, wherein the back mount and stand are configured to define, relative to a supporting surface, the angles of the horizontal, vertical, and inclined positions.

11. The electrophoresis apparatus of claim 10, further comprising a foot for engaging the supporting surface.

12-14. (canceled)

15. A method of assembling an electrophoresis apparatus having a blue light system and comprising a tiltable chamber for electrophoresis, wherein the tiltable chamber is configured to operate in a horizontal position, a vertical position, and in one or more inclined positions having an angle between the angle of the horizontal position and the angle of the vertical position, with the proviso that the angles of the one or more inclined positions are defined without a user's holding the chamber, wherein the chamber includes a chamber frame and having a front side positioned to a viewable surface of the chamber, which comprises:
placing into the chamber frame an LED panel having the blue light system and; and
placing a deflector between the LED panel and the viewable surface of the chamber.

16. The method of claim 15, further comprising placing a gel cassette between the deflector and the viewable surface of the chamber.

17. A method of separating molecules using an electrophoresis apparatus having a blue light system and comprising a tiltable chamber for electrophoresis, wherein the tiltable chamber is configured to operate in a horizontal position, a vertical position, and in one or more inclined positions having an angle between the angle of the horizontal position and the angle of the vertical position, with the proviso that the angles of the one or more inclined positions are defined without a user's holding the chamber;
wherein the chamber includes a chamber frame containing an LED panel having the blue light system and having a front side positioned to a viewable surface of the chamber; and a deflector between the LED panel and the viewable surface of the chamber;
further comprising a gel cassette between the deflector and the viewable surface of the chamber, wherein the gel cassette comprises a gel and the molecules to be separated;
further comprising a detachable stand reversibly attachable to the chamber frame; comprising:
applying a voltage to the gel containing the molecules to be separated and a fluorescent dye;
illuminating the blue light system onto the gel containing the molecules to be separated and the fluorescent dye; and
observing luminescence from the fluorescent dye when the tiltable chamber is operating an inclined position having an angle between the angle of the horizontal position and the angle of the vertical position.

18-19. (canceled)
